(19) United States
(12) Patent Application Publication
(10) Pub. No.: US 2014/0318325 A1
(43) Pub. Date: Oct. 30, 2014

(54) STRUCTURE OF A RATCHET WRENCH

(71) Applicant: Cheng-Kun CHEN, Tianzhong Township (TW)

(72) Inventor: Cheng-Kun CHEN, Tianzhong Township (TW)

(21) Appl. No.: 13/869,801

(22) Filed: Apr. 24, 2013

(51) Int. Cl. B25B 13/46

(52) U.S. Cl. CPC B25B 13/462
USPC 81/63.1

(57) ABSTRACT

The structure of a ratchet wrench has a ratchet and a brake wheel that engage with each other, and a redirecting mechanism which switchs the rotating direction of the ratchet. The redirecting mechanism has a transmission axle pivotally installed inside the brake wheel. The transmission axle has a pushing assembly for pushing the brake wheel to deviate. The pushing assembly changes its pushing direction as the transmission axle rotates, thereby changing the rotatable direction of the ratchet.

### BACKGROUND OF THE INVENTION

1. Field of Invention

The invention relates to the structure of a ratchet wrench and, in particular, to the structure of a ratchet wrench that can be quickly assembled and can switch the rotating direction of the ratchet.

2. Related Art

A conventional ratchet wrench, as shown in FIG. 5, has a body 51 with an accommodating space 52 and a concave chamber 53 in communications with the accommodating space 52. A ratchet 54 is disposed in the accommodating space 52. A redirecting device 55 is provided in the concave chamber 53. The redirecting device 55 has two brake blocks 56, two elastic elements 57, and a switching element 58 interposed between the two brake blocks 56 to selective push one of them to deviate. The brake block 56 that is not urged by the switching element 58 is urged by the corresponding elastic element 57 to engage the ratchet 54 in a single direction.

However, the above-mentioned conventional ratchet wrench has the drawback of time-consuming in assembly and higher costs in its components. Using only one brake block to engage the ratchet in a single direction often has insufficient strength and torsion resistance, resulting in erosion and slipping.

Therefore, the conventional ratchet wrench is not perfect in the structure. It is the goal of the invention to provide a better solution.

### SUMMARY OF THE INVENTION

An objective of the invention is to provide a structure of a ratchet wrench that has a simple structure to reduce the number of components and the costs thereof. The assembly is thus easier and faster.

Another objective of the invention is to provide a structure of a ratchet wrench that has extremely good strength and torsion resistance. Therefore, in practice, the invention has less erosion and slipping.

To achieve the above-mentioned objectives, the disclosed ratchet wrench includes:

a body having a first tank and a second tank, the first tank being provided with a ratchet surrounded by a ratchet part and the two opposite sides inside the second tank having respectively an engaging tooth section;

a brake wheel disposed inside the second tank and having an accommodating space, the brake wheel being surrounded by a brake tooth part to engage with the tooth part of the ratchet, and a stopping tooth part to engage with one of the engaging tooth sections of the second tank; and

a redirecting mechanism disposed in the second tank and having a transmission axle pivotally provided in the accommodating space of the brake wheel; the transmission axle having a pushing assembly to pushing the inner side of the accommodating space, thereby pushing the brake wheel to deviate; wherein the pushing assembly is free to change the pushing direction as the transmission axle rotates so that the stopping tooth part of the brake wheel selectively engages with one of the engaging tooth sections of the second tank, thereby changing the rotatable direction of the ratchet.

Preferably, the two engaging tooth sections are composed to many continuously aligned teeth. The stopping tooth part is provided at the end surface of the tooth peak of the brake tooth part. The brake tooth part and the stopping tooth part surround respectively the outer surrounding surface of the brake wheel of the same height.

Preferably, the transmission axle has a concave space for accommodating the pushing assembly. The pushing assembly is comprised of an urging block and an elastic element. The elastic element elastically pushes the urging block to urge against the inner side of the accommodating space for pushing the brake wheel to deviate.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is an exploded view of the invention;

FIG. 2 is a schematic view of the invention after assembly;

FIG. 3 is a schematic view of the invention in use, showing that when one drives the body in reverse the stopping tooth part of the brake wheel rolls away from the engaging state with the engaging tooth section;

FIG. 4 is a schematic view of the invention in use, showing the state of switching the pushing direction of the pushing assembly; and

FIG. 5 is a schematic view of a conventional ratchet wrench.

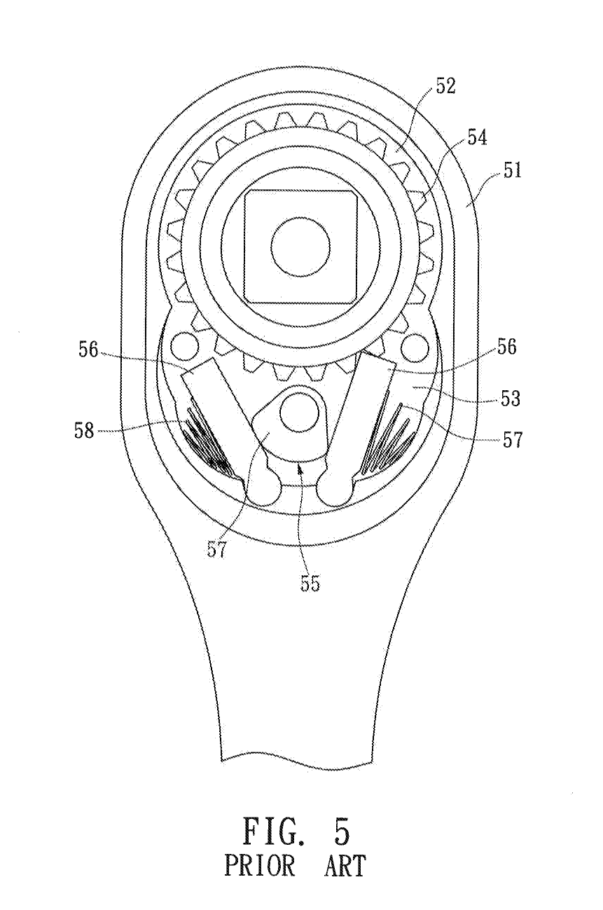

### DETAILED DESCRIPTION OF THE INVENTION

The present invention will be apparent from the following detailed description, which proceeds with reference to the accompanying drawings, wherein the same references relate to the same elements.

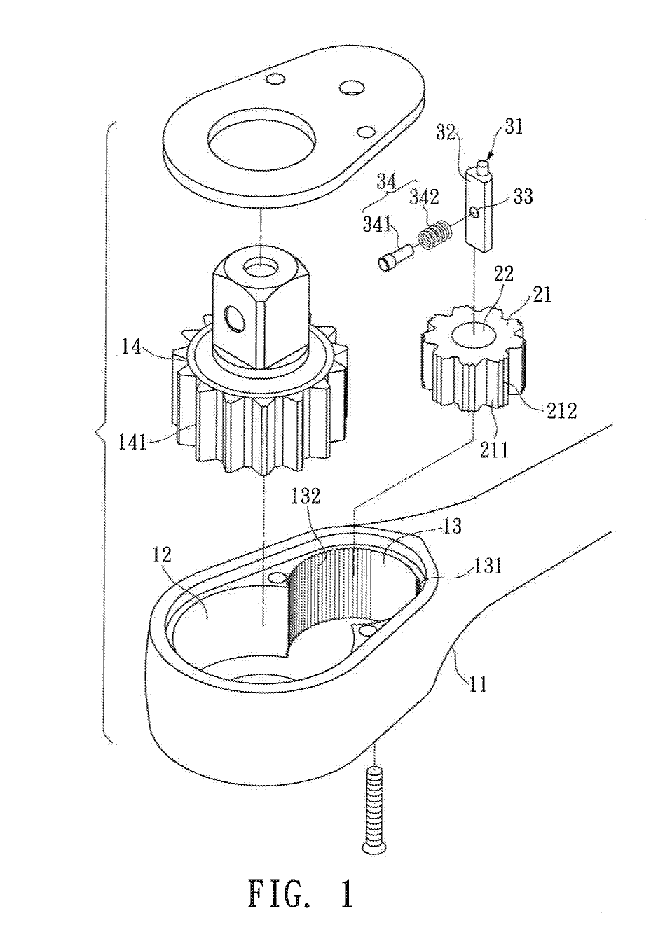

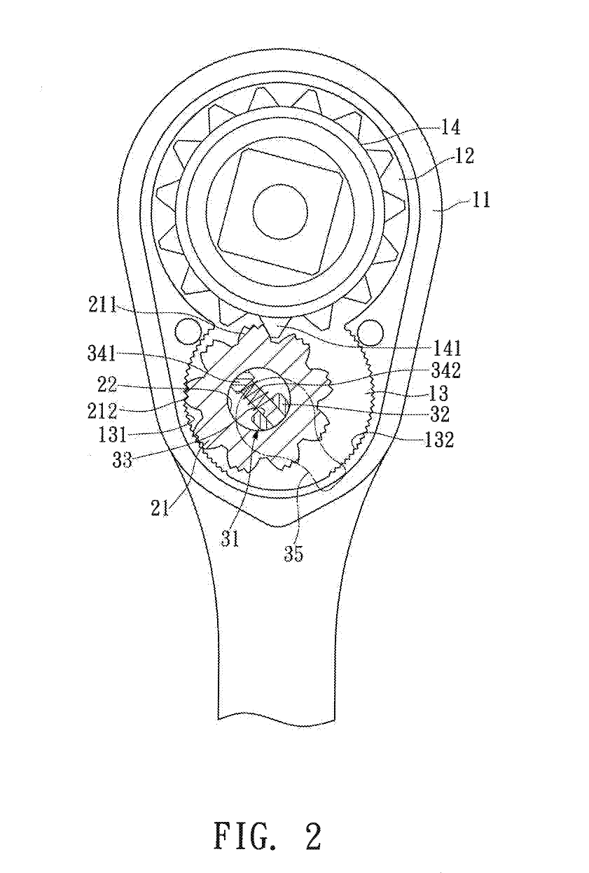

Please refer to FIGS. 1 and 2 for the structure of a ratchet wrench of the invention. It consists of a body 11, a brake wheel 21, and a redirecting mechanism 31.

The body 11 has a first tank 12 and a second tank 13. In this embodiment, the first tank 12 and the second tank 13 are connected. The first tank 12 has a ratchet 14 whose outer surrounding surface is surrounded by a ratchet part 141. The two opposite sides on the inner side of the second tank 13 have respectively an engaging tooth section 131, 132 composed of many continuously aligned teeth.

The brake wheel 21 is disposed inside the second tank 13. The brake wheel 21 is formed with an accommodating space 22. The outer surrounding surface of the brake wheel 21 has a brake tooth part 211 to engage with the ratchet part 141 of the ratchet 14 and a stopping tooth part 212 to engage with one of the engaging tooth. sections 131, 132 of the second tank 13. In this embodiment, the end surface of the tooth peak of the brake tooth part 211 has a stopping tooth part 212 composed of many small teeth. The brake tooth part 211 and the stopping tooth part 212 surround respectively the outer surrounding surface of the brake wheel 21 of the same height.

The brake wheel 21 is driven by the ratchet 14 to roll and deviate toward one of the engaging tooth sections 131 of the second tank 13 (the left engaging tooth section in FIG. 2). The stopping tooth part 212 engages the engaging tooth section 131. When the ratchet 14 drives the brake wheel 21 to roll. and engage the engaging tooth section 131, a wedge reaction is formed to firmly stop the rotation of the ratchet 14. Finally, the torsion that drives the ratchet 14 is canceled. This is the brake state.

The redirecting mechanism 31 is disposed inside the second tank 13. The redirecting mechanism 32 has a transmission axle 32 pivotally provided in the accommodating space 22 of the brake wheel 21 to pivotally rotate with respect to the accommodating space 22. The transmission axle 32 has a concave space 33 for accommodating a pushing assembly 34. In this embodiment, the pushing assembly 34 consists of an urging block 341 and an elastic element 342. The elastic element 342 elastically pushes the urging block 341 to urge against the inner side of the accommodating space 22, thereby pushing the brake wheel 21 to deviate. The pushing assembly 34 can change its pushing direction as the transmission axle 32 pivotally rotates. This pushes the brake wheel 21 to deviate. The stopping tooth part 212 of the brake wheel 21 can selectively engage with one of the engaging tooth sections 131, 132 of the second tank 13, thereby changing the rotatable direction of the ratchet 14.

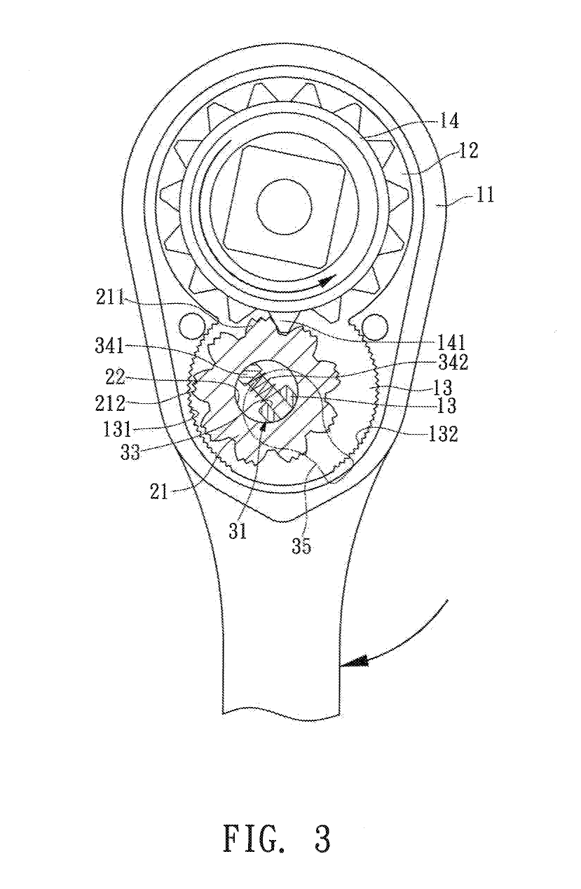

When driving the body 11 in reverse, as shown in FIG. 3, the stopping tooth part 212 of the brake wheel 21 rolls away from the engaging tooth section 131 that is originally engaged to compress the pushing assembly 34, thereby releasing the engaging state with the engaging tooth section 131. Since, the wedge reaction disappears, the ratchet 14 can thus rotate freely in reverse. This enables driving in a single direction.

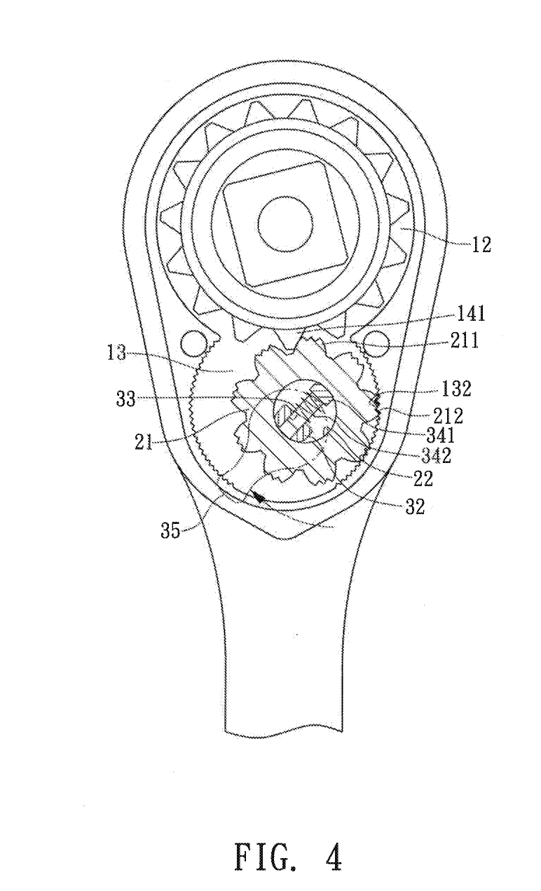

When a user wants to change the rotating direction of the wrench, as shown. in FIG. 4, he or she only needs to flick a switch 35 at the top of the transmission axle 32. This action enables the transmission axle 32 to rotate synchronously with the pushing assembly 34. The pushing assembly 34 can push the brake wheel 21 to deviate toward the other side. The stopping tooth part 212 of the brake wheel 21 then engages in a single direction with the engaging tooth section 132 on the right side of the second tank 13. Therefore, the invention can switch between two opposite directions in the driving force of the wrench.

In comparison with the prior art, the invention makes use of the wedge reaction to achieve single-direction driving. Therefore, it is not necessary to employ additional elastic elements and urging brake blocks. Not only does the invention have a simpler structure than the prior art, its assembly is also easier. The invention uses the stopping tooth part 212 of the brake wheel 21 and the engaging tooth sections 131, 132 in the second tank 13 to form the single-direction engaging structure. It has extremely good strength and torsion resistance. Therefore, the invention works more firmly without erosion or slipping.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A ratchet wrench structure comprising:
a body having a first tank and a second tank, the first tank being provided with a ratchet surrounded by a ratchet part and the two opposite sides inside the second tank having respectively an engaging tooth section;
a brake wheel disposed inside the second tank and having an accommodating space, the brake wheel being surrounded by a brake tooth part to engage with the tooth part of the ratchet, and a stopping tooth part to engage with one of the engaging tooth sections of the second tank; and
a redirecting mechanism disposed in the second tank and having a transmission axle pivotally provided in the accommodating space of the brake wheel; the transmission axle having a pushing assembly to pushing the inner side of the accommodating space, thereby pushing the brake wheel to deviate; the pushing assembly being free to change the pushing direction thereof as the transmission axle rotates, so that the stopping tooth part of the brake wheel selectively engages with one of the engaging tooth sections of the second tank, thereby changing the rotatable direction of the ratchet.

2. The ratchet wrench structure of claim 1, wherein the two engaging tooth sections are comprised of a plurality of continuously aligned small teeth.

3. The ratchet wrench structure of claim 1, wherein the stopping tooth part is provided at the end surface of the tooth peak of the brake tooth part, the brake tooth part and the stopping tooth part surround respectively the outer surrounding surface of the brake wheel of the same height.

4. The ratchet wrench structure of claim 1, wherein the transmission axle has an concave space for accommodating the pushing assembly, the pushing assembly consists of an urging block and an elastic element, and the elastic element elastically pushes the urging block to urge against the inner side of the accommodating space, thereby pushing the brake wheel to deviate.
